(19) United States
(12) Patent Application Publication
(10) Pub. No.: US 2018/0019522 A1
(43) Pub. Date: Jan. 18, 2018

(54) PROTECTION DEVICE

(71) Applicant: Kirintec Limited, Herefordshire (GB)

(72) Inventor: Roy Peter Peers-Smith, Herefordshire (GB)

(21) Appl. No.: 15/446,347

(22) Filed: Mar. 1, 2017

(30) Foreign Application Priority Data
Jul. 13, 2016 (GB) 1612155.0

(51) Int. Cl. H01Q 17/00; H01Q 7/00; H01Q 1/27

(52) U.S. Cl. CPC H01Q 17/007; H01Q 17/001; H01Q 1/273; H01Q 7/00

(57) ABSTRACT

A protection device is described that comprises a covering 12 incorporating an electromagnetic screening layer 20, a first antenna 24, a second antenna, and an inhibitor device 32 operable to cause the first and second antennae to transmit respective inhibiting signals at or over respective frequencies or frequency ranges into a volume 18 enclosed, at least in part, by the covering 12, in use.

### BACKGROUND OF THE INVENTION

### 1. Field of the Invention

This invention relates to a protection device, and in particular to a protection device intended for use in protecting against injury or damage caused by explosions, for example in the event that a suspect package or object which is thought may contain an explosive device is located.

### 2. Description of Related Art

Where suspicious packages, items of luggage or the like are found, it is known to place a blast suppression device, for example in the form of a blast suppression blanket, over the package or the like to contain fragments in the event that an explosive device within the package or the like detonates. Clearly, containment of such fragments reduces the risk of injury to individuals close to the package or the like, and also reduces the risk of damage in the surrounding area.

A number of blast suppression devices are known. For example, GB 1459743 and U.S. Pat. No. 3,648,613 both describe blast blankets designed for this purpose, the blankets including a number of layers of a suitable ballistics material to resist tearing or rupturing of the blanket and avoid or reduce the passage of fragments through the material. In the event of detonation, fragments resulting from the explosion are thus contained by the blast suppression device. Consequently, the risk of damage or injury is reduced. DE 19717474 describes a blast suppression device intended for use in mailrooms or the like and into which suspect letters or small packages can be placed so as to contain fragments in the event of explosion.

Although such devices may be successful in reducing the risk of injury or damage in the event of an explosion, it would be preferable to prevent detonation and thereby further reduce the risk of injury or damage.

GB2470123 describes an arrangement in which a covering is provided to be positioned over or around a suspect package or the like, the covering incorporating an electromagnetic screening layer. An antenna associated with an inhibitor device is located within the volume defined, in part, by the screening layer, for example by being stitched to the covering. In such an arrangement, the screening layer serves to reduce the risk of reception of transmitted command signals that, if received, could trigger detonation. The inhibitor device and associated antenna transmit an inhibiting signal into the volume defined, in part, by the covering, thereby further reducing the likelihood of a transmitted command signal being received.

### SUMMARY OF THE INVENTION

### Objective of the Invention

Whilst the arrangement of GB2470123 has been found to operate satisfactorily, modifications to, for example, cellular communications technology as resulted in there being a need for an arrangement capable of inhibiting the reception of command signals transmitted over a wide range of frequencies. It is an object of the invention to provide a protection device in which at least some of the limitations associated with known devices are overcome or are of reduced effect.

According to an aspect of the invention there is provided a protection device comprising a covering incorporating an electromagnetic screening layer, a first antenna, a second antenna, and an inhibitor device operable to cause the first and second antennae to transmit respective inhibiting signals at or over respective frequencies or frequency ranges into a volume enclosed, at least in part, by the covering, in use.

It will be appreciated that by providing two or more antennae, and arranging for the inhibitor device to transmit inhibiting signals via the antennae at or over different frequencies or frequency ranges, the reception of command signals transmitted over a wider range of frequencies to an item located within the volume defined, in part, by the covering is impeded.

The first antenna conveniently takes substantially the form of a loop. The loop is preferably suspended at a position spaced inwardly of the screening layer.

The second antenna conveniently takes the form of a discrete antenna, conveniently located within a housing. The second antenna could take a range of forms, for example comprising a suitable conductor or a conductive track on a PCB. One or more additional antenna may be provided adjacent and associated with the second antenna and connected to the inhibitor device to allow the transmission of inhibitor signals over further frequency ranges.

The second antenna is conveniently suspended from the cover. Where one or more additional antennae are provided, these are preferably suspended with the second antenna. Preferably, the manner in which the second antenna is suspended allows adjustment of the position of the second antenna. By way of example, it may be carried upon a strap or straps of adjustable length. A hook and loop fastener may be used to adjust the length of the strap or straps.

It will be appreciated that by supporting the second antenna in this manner, the second antenna may be located very close to the suspect item. As a result, effective inhibition can be achieved without the need for the transmission of an excessively powerful inhibiting signal. The risk of disruption to communications in the vicinity of the protection device is reduced.

The inhibitor device may incorporate additional variable signal sources such as programmable voltage controlled oscillators operable to generate the inhibitor signals for transmission via the first and second antennae.

The covering may further incorporate ballistics materials.

The covering may be supported upon a frame. The frame may be of a flexible or foldable form. Alternatively, the frame may be of an inflatable form.

According to another aspect of the invention there is provided a protection device comprising a covering incorporating an electromagnetic screening layer, an antenna, and an inhibitor device operable to cause the antennae to transmit an inhibiting signal into a volume enclosed, at least in part, by the covering, in use, wherein the antenna is suspended from the covering. Preferably, the manner in which the antenna is suspended allows adjustment of the position of the antenna. By way of example, it may be carried upon a strap or straps of adjustable length. A hook and loop fastener may be used to adjust the length of the strap or straps.

### BRIEF DESCRIPTION OF THE DRAWINGS

The invention will further be described, by way of example, with reference to the accompanying drawings, in which:

FIG. 1 is a diagrammatic view illustrating a protection device in accordance with an embodiment of the invention.

### DESCRIPTION OF THE PREFERRED EMBODIMENT(S)

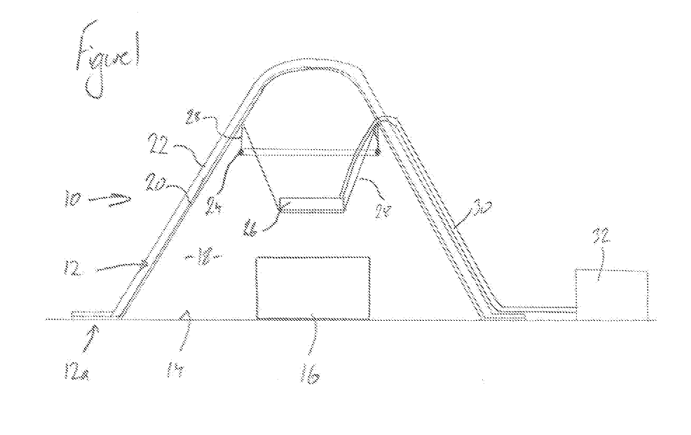

Referring to FIG. 1, a protection device 10 is illustrated. The protection device 10, in common with that described in GB2470123, comprises a covering 12 of flexible form and supported upon a frame (not shown). The frame could comprise, for example, a metallic, foldable frame, preferably of flexible form. Alternatively, it could be of inflatable form. It will be appreciated, however, that a wide range of frames or other supports for the covering 12 may be provided. Indeed, arrangements are possible in which the covering 12 has sufficient inherent strength that no separate frame is required to provide support, or in which the covering 12 is simply draped over an item, in use. The covering 12 is of larger dimensions that the frame so as to include edge regions 12a that rest upon a ground surface 14, in use. As shown, in use, the covering 12 is positioned over a suspect item 16 and defines, with the ground surface 14, a volume 18 surrounding the item 16.

The covering 12 includes an inner layer 20 in the form of an electromagnetic screening material, and an outer layer 22 in the form of a suitable ballistics material. It will be appreciated that the presence of the inner layer 20 attenuates the transmission of electromagnetic signals into the volume 18. Accordingly, if the item 16 includes a radio receiver operating to detonate part of the item 16 upon the receipt of a command signal, the likelihood of reception of the command signal is reduced by the presence of the inner layer 20. The ballistics material outer layer 22 provides protection in the event that the item 16 detonates, reducing or restricting the distance through which fragments thereof are projected in such an event.

In accordance with the invention, located within the volume 18 are a first antenna 24 and a housing 26 containing a second antenna. The second antenna conveniently takes the form of a discrete conductor located within the housing 26, but it will be appreciated that it could take other forms. The first antenna 24 takes substantially the form of a loop suspended from the covering 12 by support 28. The support 28 may take the form of a ring of a flexible material, for example a suitable textile material. The support 28 carries the first antenna at a location spaced inwardly of the electromagnetic screening inner layer 20 by a small distance. In the arrangement shown, the first antenna 24 is located at a position spaced from the apex of the covering 12 by approximately one third of the height of the covering 12. It will be appreciated that this represents just one example, and that the invention is not restricted in this regard. The position of the first antenna 24 is selected in such a manner as to ensure that an inhibiting signal transmitted therefrom, in use, can be reliably received throughout substantially the entirety of the volume 18. By spacing the first antenna 24 from the covering 12, it will be appreciated that the risk of parts of the covering 12 impeding the transmission of a signal from the antenna 24 to parts of the volume 18 is reduced. Also, signal transmission power may be reduced without negatively impacting upon received signal strength within parts of the volume 18.

The housing 26 containing the second antenna is supported upon straps 30 adjustably secured to the covering 12, the manner in which the straps 30 are secured to the covering 12 being such as to allow the effective lengths thereof, and hence the height at which the housing 26 is supported within the volume 18, to be adjusted. By way of example, the straps 28 may include hook and look material fasteners, allowing them to be adjustably secured to the covering.

By arranging for the position of the housing 26 to be adjustable, in use, it can be supported very close to the item 16, thereby maximising the inhibiting effect of an inhibiting signal transmitted therefrom.

The housing 26 may further contain one or more additional similar antennae.

The first antenna 24 and the second antenna (and any further antennae) are connected by means of a multi-core cable 30 to an inhibitor device 32 operable to generate respective inhibitor signals for transmission by the antennae. By way of example, the inhibitor device 32 may include a plurality of variable signal sources such as programmable voltage controlled oscillators arranged to generate the respective inhibitor signals.

In use, upon identifying that a suspicious item 16 is present, the covering 12 is positioned over the item, the cable 30 is connected to the inhibitor device 32 and the inhibitor device 32 is used to transmit, via the first and second antennae, at least, inhibiting signals into the volume 18. Before positioning the covering 12, the straps 28 may be adjusted so as to ensure that the housing 26 is supported as a suitable level close to the item 16. As described hereinbefore, the presence of the covering 12 attenuates external signals transmitted to the item 16, and provides physical protection in the event of detonation. The inhibiting signals serve to further reduce the likelihood of reception of a command signal by the item, and so reduce the likelihood of remotely controlled detonation. The inhibiting signals are contained, primarily, within the volume 18 by the covering 12, and so the continued operation of communications equipment in the vicinity of the protection device 10 is not particularly impeded.

It will be appreciated that by providing a plurality of antennae, the protection device is able to transmit inhibiting signals at or over a wider range of frequencies than is possible using a single antenna. As a result the device may be used to inhibit the reception of command signals transmitted over, for example 3G and 4G cellular networks, as well as by, for example, VHF and other wireless communications bands. By appropriate location of the antennae within the volume 18, the transmission of the inhibiting signals at an unnecessarily high signal strength is avoided, aiding containment thereof.

Whilst a specific embodiment of the invention is described hereinbefore, it will be appreciated that a wide range of modifications and alterations may be made without departing from the scope of the invention as defined by the appended claims.

Thus, having described the invention, what is claimed is:

1. A protection device comprising a covering incorporating an electromagnetic screening layer, a first antenna, a second antenna, and an inhibitor device operable to cause the first and second antennae to transmit respective inhibiting signals at or over respective frequencies or frequency ranges into a volume enclosed, at least in part, by the covering, in use.

2. A device according to claim 1, wherein the first antenna takes substantially the form of a loop.

3. A device according to claim 2, wherein the loop is suspended at a position spaced inwardly of the screening layer.

4. A device according to claim 1, wherein the second antenna takes the form of a discrete antenna.

5. A device according to claim 4, wherein at least one additional antennae is associated with the second antenna and connected to the inhibitor device to allow the transmission of inhibitor signals over further frequency ranges.

6. A device according to claim 1, wherein the second antenna is suspended from the cover.

7. A device according to claim 6, wherein the manner in which the second antenna is suspended allows adjustment of the position of the second antenna.

8. A device according to claim 7, wherein the second antenna is supported upon a strap or straps of adjustable length.

9. A device according to claim 8, wherein a hook and loop fastener is used to adjust the length of the strap or straps.

10. A device according to claim 1, wherein the inhibitor device incorporates a plurality of variable signal sources operable to generate the inhibitor signals for transmission via the first and second antennae.

11. A device according to claim 1, wherein the covering further incorporates ballistics materials.

12. A device according to claim 1, wherein the covering is supported upon a frame.

13. A device according to claim 12, wherein the frame is of a flexible or foldable form, or is of an inflatable form.

14. A protection device comprising a covering incorporating an electromagnetic screening layer, an antenna, and an inhibitor device operable to cause the antennae to transmit an inhibiting signal into a volume enclosed, at least in part, by the covering, in use, wherein the antenna is suspended from the covering.

15. A device according to claim 14, wherein the manner in which the antenna is suspended allows adjustment of the position of the antenna.

16. A device according to claim 15, wherein the antenna is carried upon a strap or straps of adjustable length.

17. A device according to claim 16, wherein a hook and loop fastener is used to adjust the length of the strap or straps.
